(19) United States
(12) Patent Application Publication
(10) Pub. No.: US 2007/0089076 A1
(43) Pub. Date: Apr. 19, 2007

(54) Application of consistent cycle context for related setup and hold tests for static timing analysis

(75) Inventor: Matthew J. Amatangelo, Austin, TX (US)

Correspondence Address: SUN MICROSYSTEMS, INC. c/o DORSEY & WHITNEY, LLP, 370 SEVENTEENTH ST., SUITE 4700, DENVER, CO, 80202, US

(73) Assignee: Sun Microsystems, Inc.

(21) Appl. No.: 11/251,184

(22) Filed: Oct. 14, 2005

(51) Int. Cl. G06F 17/50

(52) U.S. Cl. 716/6

(57) ABSTRACT

A technique for performing static timing analysis of an integrated circuit design provides a relationship between reference events of a setup test and a hold test for a particular signal path of an integrated circuit design. The relationship between the reference events of the setup and hold tests is used to compute a timing metric (e.g., slack) for at least one of the setup and hold tests to reduce the occurrence of timing escapes from the static timing analysis of the design. A static timing analyzer determines, with respect to edges of a reference signal, a signal capture event time for one of setup and hold timing metrics associated with a signal path. The capture event time is based on a capture event time for the other of the setup and hold timing metrics, a launch event time, and a test device type associated with the path.

### BACKGROUND

1. Field of the Invention

This invention relates to integrated circuits in general, and more particularly to static timing analysis of integrated circuit designs.

2. Description of the Related Art

In a typical design process flow (FIG. 1), a register transfer level (RTL) design description is synthesized to generate a gate level design description of an integrated circuit which is then placed and routed into a layout design description. Prior to place and route of the gate level design, static timing analysis identifies timing violations in the gate level design based on, e.g., a particular technology library, timing models, and general commands. Information generated by the static timing analysis tool (e.g., in a report) may be used to constrain timing paths during circuit synthesis to reduce timing violations. After place and route, delay information and detailed parasitic information may be extracted from the layout design description and provided to the static timing analysis tool to identify timing violations in the layout design. Information generated by the static timing analysis tool (e.g., in a report) may be used to constrain the gate level design description to reduce timing violations.

A typical static timing analysis tool analyzes a synchronous design description (e.g., gate level design description or a layout design description) for timing violations by breaking down the design into individual timing paths having a startpoint (i.e., a place in a design where data is launched by a reference signal edge, e.g., at an output port of a sequential element) and an endpoint (i.e., a place in the design where data is captured by a reference signal edge, e.g., at an input port of a sequential element). The static timing analysis tool calculates a signal propagation delay corresponding to an individual path, which may include cell delays and interconnect delays (e.g., delays estimated from a wire load model or delays back-annotated from layout design files). Violations of timing constraints (e.g., setup and hold timing constraints) are determined based on the timing paths and signal propagation delays.

In general, synchronous design techniques assume that signals propagate from startpoint to endpoint along each path within one cycle of a reference signal, that the reference signal is not gated (i.e., the reference signal provided as an input to a combinatorial cell or on a data terminal of sequential cells) and that only one edge (i.e., rising edge or falling edge) of the reference signal is used to trigger events. In addition, the reference signal edge associated with a launch event of data from the startpoint is assumed to be different from the reference signal edge associated with a capture event of the data at the endpoint. If a synchronous design violates these assumptions, a typical static timing analysis tool may not properly calculate startpoints, endpoints, and/or propagation delays. Thus, such paths violating timing constraints may be undetected by typical static timing analysis tools.

### SUMMARY

A technique for performing static timing analysis of an integrated circuit design provides a relationship between reference events of a setup test and a hold test for a particular signal path of an integrated circuit design. The relationship between the reference events of the setup test and the hold test is used to compute a timing metric (e.g., slack) for at least one of the setup test and hold test to reduce the occurrence of timing escapes from the static timing analysis of the integrated circuit design.

In at least one embodiment of the invention, a static timing analyzer determines, with respect to edges of a master clock signal, a signal capture event time for one of a setup timing metric and a hold timing metric associated with a signal path. The signal capture event time for the one of the setup and hold timing metrics is based on at least a signal capture event time for the other of the setup timing metric and the hold timing metric, a signal launch event time, and a type of test device associated with the signal path.

In at least one embodiment of the invention, a method includes determining a first timing relationship corresponding to a first timing metric of a pair of timing metrics associated with a signal path of an integrated circuit design. The first timing relationship is based on at least a second timing relationship corresponding to a second timing metric of the pair of timing metrics, a third timing relationship associated with the signal path, and a type of test device associated with the signal path. The timing relationships are with respect to particular transitions of at least one reference signal of the integrated circuit design.

In at least one embodiment of the invention, a computer program product encoded in at least one computer readable medium includes instructions for determining a first timing relationship corresponding to a first timing metric of a pair of timing metrics associated with a signal path of an integrated circuit design. The first timing relationship is based on at least a second timing relationship corresponding to a second timing metric of the pair of timing metrics, a third timing relationship associated with the signal path, and a type of test device associated with the signal path. The timing relationships are with respect to particular transitions of at least one reference signal of the integrated circuit design.

### BRIEF DESCRIPTION OF THE DRAWINGS

The present invention may be better understood, and its numerous objects, features, and advantages made apparent to those skilled in the art by referencing the accompanying drawings.

FIG. 1 illustrates an exemplary design flow including static timing analysis.

FIG. 2 illustrates an exemplary integrated circuit signal path for analysis by a static timing analysis tool and corresponding timing waveforms.

FIG. 3 illustrates an exemplary timing report generated by a static timing analysis tool for the integrated circuit signal path of FIG. 2.

FIG. 4 illustrates exemplary integrated circuit signal paths for analysis by a static timing analysis tool.

FIG. 5 illustrates event timing with respect to a reference signal for the exemplary signal paths of FIG. 4 for a static timing analysis tool consistent with at least one embodiment of the invention.

FIG. 6 illustrates exemplary reference signal waveforms.

FIG. 7 illustrates an exemplary multifrequency integrated circuit signal path for analysis by a static timing analysis tool.

FIG. 8 illustrates exemplary information and control flows for an exemplary static timing analysis tool consistent with at least one embodiment of the invention.

FIG. 9 illustrates a static timing analysis tool consistent with at least one embodiment of the invention.

FIG. 10 illustrates an integrated circuit made by a static timing analysis tool consistent with at least one embodiment of the invention.

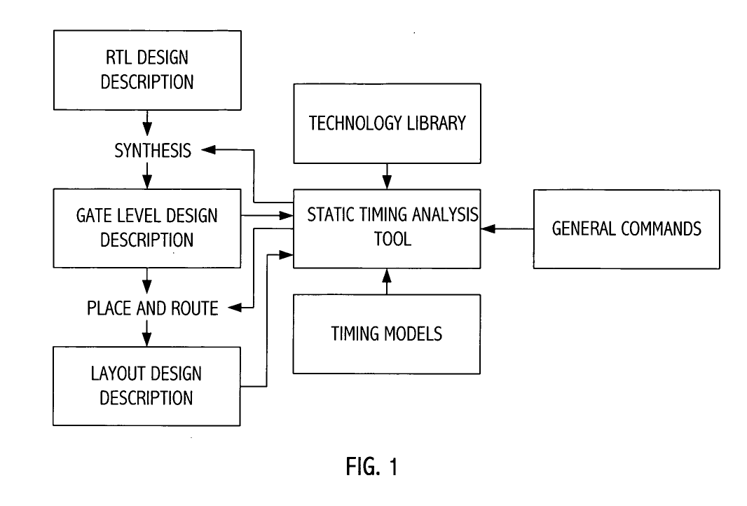

The use of the same reference symbols in different drawings indicates similar or identical items.

### DESCRIPTION OF THE PREFERRED EMBODIMENT(S)

An exemplary static timing analysis tool uses the signal propagation delay for an individual path to check for violations of timing constraints, e.g., setup and hold timing constraints. A setup timing constraint specifies an amount of time that data should be available at an input of a sequential device prior to the availability at the sequential device of a reference signal edge that effectuates data capture in the sequential device. Setup timing constraints enforce a maximum delay on the data path relative to the reference signal path. A hold timing constraint specifies an amount of time that data should be stable at the input of the sequential device after a reference signal edge that effectuates data capture in the sequential device. Hold timing constraints enforce a minimum delay on the data path relative to the reference signal path. The slack associated with a timing constraint indicates a comparison of the delay of a data path to a delay of a timing constraint (e.g., the delay of a setup timing constraint or the delay of a hold timing constraint). A positive slack indicates an amount of time by which a violation of a timing constraint is avoided by a path delay. A negative slack indicates the amount of time by which a path delay violates a timing constraint. An exemplary static timing analysis tool generates a timing report that includes e.g., the amount of slack in the path based on specified timing constraints, and/or additional timing information e.g., gate levels in the path, incremental delay values corresponding to individual gate levels, and/or a sum of total path delays.

In general, synchronous design techniques assume that signals propagate from startpoint to endpoint along each path within one cycle of a reference signal and that the reference signal is not gated, i.e., the reference signal is not provided as an input to a combinatorial cell or on a data terminal of sequential cells. However, as clock speeds increase, circuit designers may implement circuits that violate these principles of synchronous design to achieve high-speed circuit functionality. As a result, exemplary static timing analysis tools may generate“timing escapes” (i.e., situations that a static timing analysis tool should identify as timing constraint violations, but remain undetected) when analyzing such circuits, e.g., those circuits including a gated clock.

An exemplary static timing analysis tool allows circuit designers to include gated clocks and multi-cycle paths, but such design choices may require the circuit designer to guarantee timing of the path or make manual adjustments to slack calculations. For example, when including a multi-cycle path, the circuit designer may specify to the static timing analysis tool that a particular path is allowed a longer time than one cycle to propagate data. In some situations, a circuit designer may specify a zero-cycle setup timing constraint, i.e., a single reference signal edge drives both the launch and capture events for the timing constraint. In such situations, the static timing analysis tool may rely on the circuit designer timing and assumes that the circuit designer has guaranteed or specified both setup and hold tests properly. However, if only one of the setup and hold tests are specified by the designer and the static timing analysis tool determines edges of the reference signal associated with a hold test independently from the edges of the reference signal associated with the setup test, a timing escape may occur.

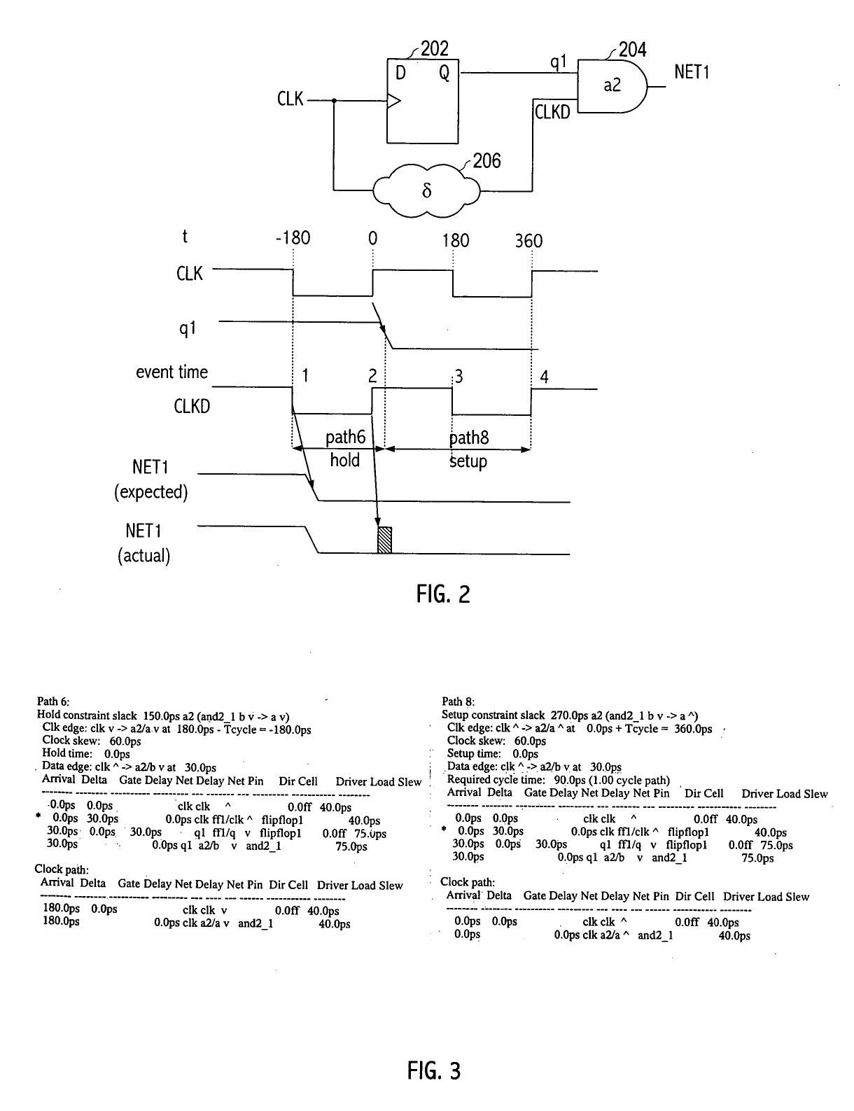

For example, referring to FIG. 2, an exemplary circuit path includes flip-flop 202, responsive to a positive edge of a reference signal (e.g., CLK) to update. Flip-flop 202 generates a data signal (e.g., q1) that is gated with a version of the reference signal (e.g., CLKD) by an exemplary combinatorial gate (e.g., AND gate 204). Delay 206 has a value δ and is an exemplary wire delay and/or combinatorial gate delay of a version of the reference signal that arrives at the input of AND gate 204 (e.g., CLKD). The value of δ may be negligible (e.g., 0ps) or may be substantial (e.g., hundreds of picoseconds). Note that a race condition exists between CLKD and q1, the outcome of the race condition depending upon the value of δ for delay 206.

An exemplary static timing analysis tool determines reference signal edges for a setup timing constraint independent from a determination of a hold timing constraint associated with a particular signal path of an exemplary circuit. In general, setup tests are not zero cycles or less, i.e., setup tests are one tick or more between source clock edges that cause new data launch and prior cycle data capture. Typically, hold tests are zero cycles or less, i.e., a source clock launching new cycle data does not happen before the source clock that captures prior cycle data. In general, for gated clocks, data must be setup before the asserting edge of the clock and held after the de-asserting edge of the clock. The asserting edge of the clock is the clock edge that will cause the output of the clock gate to initiate a pulse from its quiescent state, if the clock gate is enabled. For example, the asserting edge of a clock for a clocked nand gate or a clocked and gate is the rising edge of the input clock, e.g., data is set up before the rising edge of the clock at the nand gate and data is held until after the falling edge of the clock at the nand gate. The asserting edge for a clocked nor or a clocked or gate is falling edge of the input clock.

Since in static timing analysis all timing is referenced to a single cycle, cycle adjustments may be used to calculate slack for setup and hold timing constraints. For example, when a particular clock edge launches data and that same clock edge captures the data, the exemplary static timing analysis tool applies an adjustment to the associated slack calculation to move the capture clock edge to the next clock cycle. For example, a static timing analysis tool considers launching data as current cycle data and capture data at the end of the current cycle for setup timing constraints. Note that setup timing constraints follow a convention that an allowance between absolute source launch and capture events is greater than zero cycles. The reference signal edges provide the resolution for the allowance and are the“source” of all derived events. Typically, the minimum allowance of time for setup timing constraints between launch and capture events is one“tick” (i.e., the time between one transition edge to a next occurring transition edge) of the reference signal. That is, the reference signal edge that causes a capture event for a setup timing constraint occurs at least one tick after the reference signal edge causing the launching event in terms of absolute time. In absolute time, as compared to time modulo a cycle of the reference signal, no adjustments are applicable. . For hold timing constraints, a static timing analysis tool considers the launching data to be next cycle data and the reference capture edge to be the end of the current cycle. The timing constraints may also follow the convention that for all hold tests, the capture source event is less than one cycle before or after the launch source event. The greatest difference between launch and capture source events for a hold timing constraint is one tick of the reference signal.

The exemplary static timing analysis tool generates a timing report for exemplary circuit 200 having a negligible value of δ for delay 206 (FIG. 3). For the hold test, the next cycle data launch is initiated from the master clock edge rising at time 0. The capture clock corresponding to the de-asserting clock edge for prior cycle data is time 180. The source clock launching new cycle data happens before the source clock that captures prior cycle data, i.e., the source clock that captures the prior cycle data does not occur before next cycle data is launched. Accordingly, the exemplary static timing analysis tool adjusts the clock capture edge for the hold slack calculation by one cycle (e.g., Tcycle=360 ps), i.e., the clock capture edge for prior cycle data is adjusted to occur before next cycle data launches. The falling edge of q1 arrives at the input of AND gate 204 when CLK is 30 ps. The hold timing constraint is 0 ps from the reference signal edge (i.e., the falling reference signal edge) occurring at −180 ps. The falling edge of q1 arrives at the input of AND gate 204 when CLK is 30 ps. Since the hold timing constraint requires q1 to arrive at AND gate 204 no earlier than the edge of CLK at −180 ps and q1 arrives at AND gate 204 at 30 ps, the hold timing constraint slack for path6 is computed as follows, accounting for clock skew of 60 ps: 30 ps−(180 ps−Tcycle)−60 ps=150 ps.

For the setup timing constraint on q1 (i.e., path 8), next cycle data is initiated from the master clock edge rising at time 0 ps and the clock capture edge for prior cycle data is the same master clock edge. Since the setup test must be greater than zero cycles, the exemplary static timing analysis tool adjusts the setup slack calculation to move the capture clock to the next cycle (e.g., Tcycle =360 ps). Accordingly, the setup timing constraint requires q1 to arrive at AND gate 204 no later than the edge of CLK at 360 ps. Since q1 arrives at AND gate 204 at 30 ps, the setup timing constraint slack for path8 is computed as follows, accounting for clock skew: (0 ps+Tcycle)−(30 ps)−60 ps=270 ps. Thus, path8 is computed to have 270 ps of slack for a falling test edge of q1 at the input of AND gate 204.

However, dynamic simulation of the circuit of FIG. 2 indicates that data on q1 fails to transact to provide the expected results on NET1. Since the signal on q1 is launched from flip-flop 202 after CLKD rises at AND gate 206, in at least one situation, the signal on NET1 includes a glitch (i.e., at least one undesired transition, e.g., a transition from low to high, followed by a transition from high to low). The event on q1 should be setup against a reference signal transition at 0 ps rather than the reference signal transition at 360 ps: 0 ps−(30 ps)−60 ps=90 ps. Performing the setup test on path8 with a reference signal transition at 0 ps produces a negative slack, i.e., path8 violates the setup timing constraint.

By using the −180 ps edge of CLK, the exemplary static timing analysis tool gives the design an excessive amount of time to meet the setup and hold tests. Since, the capture edge of the setup test for the signal path of FIG. 2 was the 360 ps edge of CLK and capture edge of the hold test is at the −180 ps edge, the setup and hold timing constraints of the exemplary static timing analysis tool handle new data as being valid from at least −180 ps to +360 ps, as if more than one cycle of the reference signal (−180 ps to 360 ps) is used to perform a single transaction. However, new data is not valid for the entire 1.5 cycles of CLK and NET1 actually includes glitches and the analysis results in a timing escape.

Such timing escapes may be identified by a static timing analysis tool consistent with the present invention by considering setup and hold timing constraints in relation to one another. For example, the exemplary static timing analysis tool used the −180 ps edge of CLK for the hold timing constraint (i.e., path6 test) capture clock edge and the setup timing constraint (i.e., path8 test) capture clock edge of 360 ps. However, given the signal path of FIG. 2 and the setup timing constraint as defined by the capture clock edge of the reference signal at 360 ps, an appropriate hold timing constraint capture edge is the +180 ps edge of CLK, which would give a slack of 30 ps−180 ps−60 ps=−210 ps, a negative slack that violates the hold timing constraint.

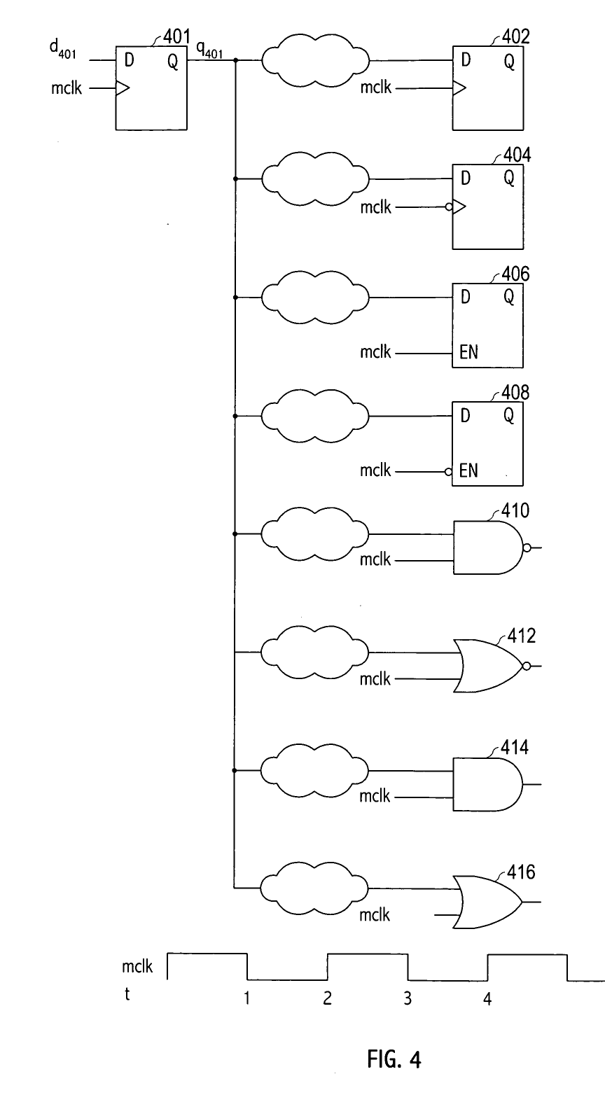

Referring to FIG. 4, signals arriving at sequential devices 402, 404, . . . , 412 with respect to a reference signal (e.g., mclk) are based on a signal launched from sequential device 401 on the rising edge (e.g., edge 2) of the reference signal. Sequential devices 402, 404, . . . , 416 include positive edge-triggered flip-flop 402, negative edge-triggered flip-flop 404, level sensitive latch transparent when the enable is high 406, level sensitive latch transparent when the enable is low 408, a NAND clock gate 410, a NOR clock gate 412, an AND clock gate 414, and an OR clock gate 416. However, the invention is not limited thereto, and an appropriate cycle context may be determined for other sequential devices. Flip-flops and latches are devices which sequence properly according to a particular edge of a reference signal, i.e., the same polarity of the reference signal (e.g., rising or falling edge of mclk) is used for both setup and hold capture events. In contrast, a gated clock requires the data to be setup before an asserting edge of the reference signal and held beyond the de-asserting edge of the reference signal because the critical interval, where changes to the data can cause a logical failure at the output, is one entire phase of the reference signal. Such critical interval and setup and hold timing constraints also apply to dynamic logic (e.g., precharge logic).

A static timing analysis tool consistent with the present invention determines a reference signal edge for a setup capture event time or a hold capture event time for a particular signal path of an integrated circuit based on a setup launch event time, a hold launch event time, the other of the setup capture event time or the hold capture event time, and a type of circuit associated with the particular signal path. An edge of a reference signal at which a capture event occurs and an edge of the reference signal corresponding to an associated data launch is referred to herein as the cycle context. The cycle context also depends on the type of device at which the test occurs to determine whether or not the timing constraints use both rising and falling edges of the reference signal for proper sequencing.

The test context for a particular signal path includes the setup capture event edge and the hold capture event edge with respect to edges of the reference signal (e.g., mclk) when a signal is launched from a sequential device (e.g., sequential device 401) on a particular edge of the reference signal (e.g., edge 2 of mclk). For example, the signal path tested at sequential device 402 that was launched by mclk edge 2 needs to arrive before the reference signal transition at sequential device 402 launched by mclk edge 4 arrives, and it must arrive after the reference signal transition at sequential device 402 launched by mclk edge 2. Note that the clock signals arriving at sequential devices 402, 404, . . . , 416 may be delayed from the reference signal and from each other. Although each sequential device is illustrated as receiving mclk events simultaneously, mclk events may not necessarily be received simultaneously. Individual ones of sequential devices 402, 404, . . . , 416 receive a reference signal edge as a result of a source occurrence, but not necessarily simultaneously with that source occurrence. The test contexts provide relationships between launch and capture events associated with driving sequential device 401 and receiving sequential devices 402, 404, . . . , 416.

The discussion that follows applies reference signal modulo timing, i.e., events are considered relative to the single reference signal and two transitions associated therewith, the leading and trailing edges. Both launching and capturing events are derived from these reference signal transitions. The actual arrival time of an event at a test device derived from the launching edge of the reference signal is referred to herein as AT. The actual arrival time of the reference event at a test device, derived from the master clock, establishes a timing constraint for the tested signal and is referred to herein as the required time, RT. Accordingly, the setup and hold timing metrics are:
Slack(Setup)=(RT+adjust)−AT (EQ. A)
Slack(Hold)=AT−(RT+adjust). (EQ. B)

An adjustment (e.g., adjust) may be applied to the required times to ensure that the reference signal edge that causes a capture event for a setup timing constraint occurs at least one tick after the reference signal edge causing the launching event in terms of absolute time or that the capture source event is less than one cycle before or after the launch source event for a hold timing constraint. Referring to FIG. 6, if the reference signal is consistent with waveform 502 and the launching event of the hold test (e.g., AT =2) occurs before the capture edge (e.g., RT =3) then no adjustment is applied to the slack computation for the hold timing constraint (i.e., EQ. B). If the reference signal is consistent with waveform 504 of FIG. 6 and the capture event, RT, occurs at mclk edge 3−T=1, which occurs before the launch edge, AT=2. Hence, an adjustment to the slack computation for the hold timing constraint (i.e., EQ. B) is adjusted by +1 cycle.

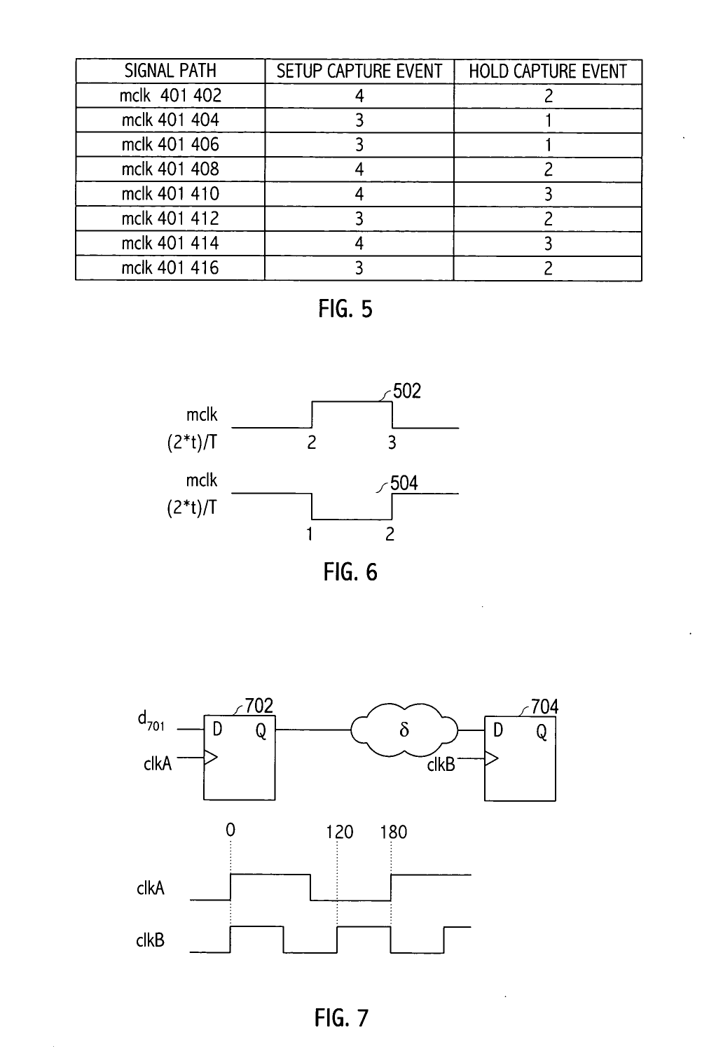

Determination of an edge of the reference signal corresponding to a setup or hold reference event depends on the type of sequential test device receiving the signal. The reference signal times that derive a reference event (e.g., capture event) and a tested event (e.g., launch event) for a setup timing constraint are RT_{SETUP} and AT_{SETUP}, respectively. The reference signal transitions that derive a reference event (e.g., capture event) and a tested event (e.g., launch event) for a hold timing constraint are RT_{HOLD} and AT_{HOLD}, respectively. T is the period of the reference signal. EQ. C describes the cycle contexts that apply to sequential devices that require both edges (i.e., rising and falling transitions) of the reference signal and EQ. D describes the cycle contexts that apply to sequential devices that use the same polarity of reference signal transitions for both setup and hold timing constraints (e.g., flip-flops and latches):
1/T{(RT_{SETUP}−AT_{SETUP})−(RT_{HOLD}−AT_{HOLD})}=½ cycle; (EQ. C)
1/T{(RT_{SETUP}−AT_{SETUP})−(RT_{HOLD}−AT_{HOLD})}=1 cycle; (EQ. D)
Given the convention that launch and test reference signal edges are within one tick of each other for a hold timing constraint, and the relationships of EQ. C and EQ. D between setup and hold launch and capture events, the relationships provided by EQ. C and EQ. D are applied to the exemplary signal paths of FIG. 4, as summarized in FIG. 5. Note that EQ. C and EQ. D exist for pairs of signals that are to have complementary checks, which constrain a path to “setup the test signal before the reference signal edge” and “hold the test signal beyond the reference signal edge.” Given one of the setup and hold timing constraints with reference to a reference signal, EQ. C or EQ. D provides a correct cycle time for the other of the setup and hold timing constraints.

In at least one embodiment of the invention, a static timing analysis tool computes event timing modulo the reference signal. Referring to FIG. 4, signal d₄₀₁ is launched by a rising edge of mclk through sequential device 401 to sequential device 414, a device corresponding to EQ. C, which gates signal q₄₀₁ with mclk. The waveform of FIG. 4 illustrates that the number of transitions included in one cycle of mclk is T=2. Since conventionally zero cycle setup checks are not allowed, and since the path is a single-frequency path, (multifrequency paths are discussed below), the next occurring rising edge defines the capture event for the setup timing constraint. Thus, for data launched from sequential device 401 at edge two of mclk, the setup timing constraint capture event should occur at the fourth mclk edge. The launch event for the hold timing constraint occurs at edge two of mclk. According to EQ. C, the capture event for the hold timing constraint occurs at the third edge of mclk.

In at least one embodiment of the invention, the static timing analysis tool uses EQ. C and EQ. D, as applicable, to test whether the static timing analysis tool provided a correct combination of setup and hold checks for the data to transact within the allotted number of cycles. If the test fails, i.e., the static timing analysis tool failed to provide a correct combination of setup and hold checks for the data to transact within the allotted number of cycles, and the static timing analysis tool changes one of the setup and hold times, e.g., one of RT_{SETUP} and RT_{HOLD} becomes an unknown variable. Although, in general, either of RT_{SETUP} and RT_{HOLD} may be variable, a particular design may have constraints resulting in RT_{HOLD} being unknown. Regardless of which of RT_{SETUP} and RT_{HOLD} is variable, the static timing analysis tool solves for the unknown variable using EQ. C or EQ. D, as applicable and adjusts an appropriate one of RT_{SETUP} and RT_{HOLD}, accordingly (e.g., by modifying an adjustment factor for the corresponding slack computation).

Referring to the example of FIG. 2 and FIG. 3, all transactions are relevant to a single clock, e.g., CLK, because the example does not include a multicycle path. Since in the example, setup and hold checks are related to a gated clock, EQ. C applies. The static timing analysis tool determines whether 1/360 ps {(RT_{SETUP}−AT_{SETUP})−(RT_{HOLD}−AT_{HOLD})}=½. 1/360 ps {(360 ps−0 ps) −(−180 ps−0 ps)}=1½, which is not equal to ½ as required by EQ. C. Accordingly, one of RT_{SETUP} and RT_{HOLD}is changed. Since in this example, AT_{HOLD}=0 ps and RT_{HOLD} satisfies the requirement that next cycle data is not launched before current cycle data is captured with reference to the master clock, then RT_{SETUP} is the variable. Solving for RT_{SETUP}, 1/360 ps {(RT_{SETUP}−0 ps)−(−180 ps−0 ps)}=½, RT_{SETUP} is 0 ps and the adjust, which was previously 360 ps for path 8, becomes 0 ps. Thus, the static timing analysis tool establishes a zero-cycle setup timing constraint. The setup slack computation for path 8, slack(setup)=RT+adjust−AT. Since RT=0 ps−clockskew−setup time=0 ps−60 ps−0 ps=−60 ps, adjust=0 ps, and AT=30 ps, slack(setup)=−90 ps. The hold slack of path 6, which was 150 ps is valid, but the new setup slack for this data edge is −90 ps.

In at least one embodiment of the present invention, a static timing analysis tool adjusts a slack computation for a timing constraint for a multi-frequency signal path or multi-cycle signal path. For example, a setup timing constraint may be based on a launch event derived from a first reference signal and a capture event derived from a second reference signal (FIG. 7). A slack adjustment for the multi-frequency timing constraint is based on a greatest common divisor (i.e., GCD) of the two reference signal frequencies. In general, gated clocks apply to single cycle, single frequency launch/capture paths, making EQ. C inapplicable. Exemplary multi-frequency path or multi-cycle path may be analyzed using EQ. D, where T is defined as the greatest common divisor (GCD) for the multi-frequency path and T is defined as N*Tcycle otherwise, N being the number of cycles allocated for the path (e.g., when not multi-cycle, N=1).

For example, clocks (e.g., clkA and clkb) are different frequencies (e.g., TclkA=180 ps and TclkB=120 ps) and are synchronous. Clocks clkA and clkB have no phase shift to consider since the launching and capturing clock edge occur together with a common point periodically. The least common multiple (e.g., LCM) of TclkA and TclkB is 360 ps. The greatest common divisor (e.g., GCD) of TclkA and TclkB is TclkA*TclkB/LCM=120 ps*180 ps/360 ps=60 ps. If the RT_{HOLD} is 0 ps, then AT_{HOLD} is 0 ps. If AT_{SETUP}=0 ps, then RT_{SETUP}=60 ps. In other words, to to guarantee the worst-case setup slack for this multi-frequency example, the static timing analysis tool adjusts clkB from 0 ps to 60 ps rather than making a full cycle adjust. By setting RT_{HOLD}, AT_{HOLD}, and AT_{SETUP} to 0 ps, the strictest transaction interval is satisfied with the RT_{SETUP} solution.

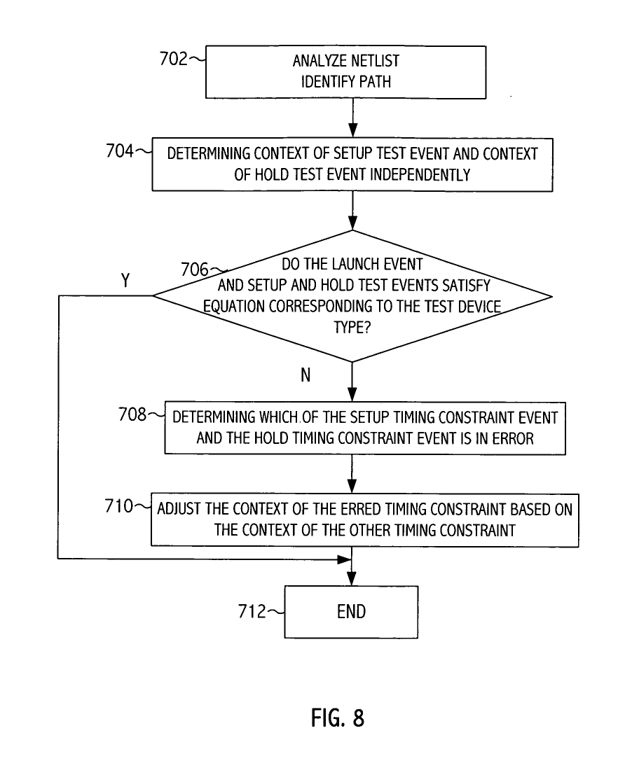

Referring to FIG. 8, a static timing analysis tool consistent with at least one embodiment of the present invention analyzes a design description (e.g., a gate level design description, a layout design description, or other suitable design description) to identify timing paths for analysis (702). For an individual timing path, the static timing analysis tool determines the cycle context of setup timing constraint and the cycle context of a hold timing constraint independently (704). The static timing analysis tool evaluates whether the contexts of the setup timing constraint and hold timing constraint satisfy cycle context relationships (e.g., EQ. C, EQ. D, or other suitable cycle context relationships) corresponding to the signal path type (706). If the appropriate context relationships are met, the static timing analysis tool exits the analysis (712) or may continue to perform the analysis on additional paths (702). If the appropriate cycle context relationships are not satisfied, the static timing analysis tool determines which of the setup timing constraint event and the hold test event is in error (708) and adjusts the cycle context of the erred test based on the cycle context of the other test (710). In at least one embodiment of the invention, the static timing analysis tool analyzes the hold timing constraint cycle context to determine which timing constraint is erred. If the static timing analysis tool determines that AT_{HOLD} and RT_{HOLD} are on opposite edges of the reference signal, then the static timing analysis tool adjusts RT_{SETUP} consistent with techniques described above.

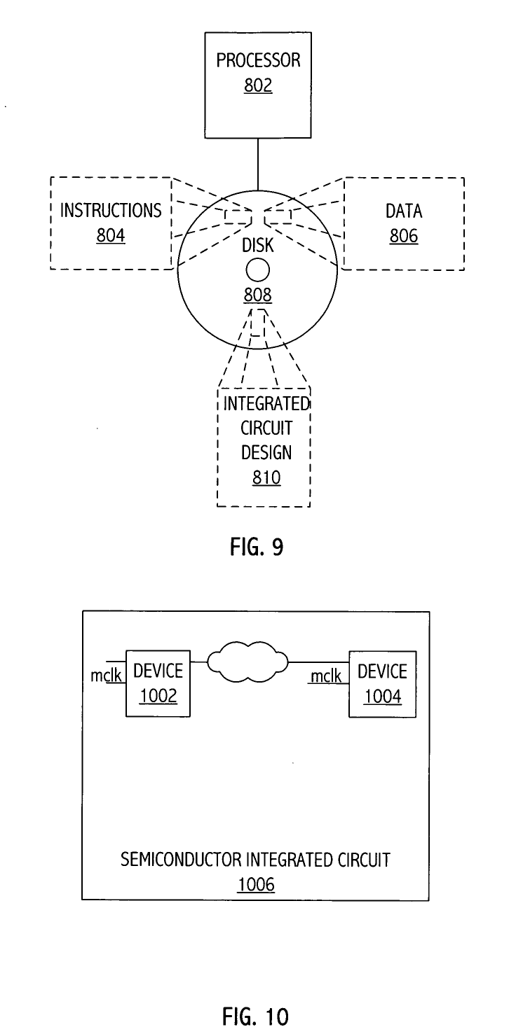

Referring to FIG. 9, a static timing analysis tool consistent with the previous discussion may be embodied in an automated computer software design tool for processing design files, which may be executed on a programmable computer (e.g., processor 802). Persons of ordinary skill in the art will recognize a variety of computer programming languages appropriate for implementing the teachings described herein. The techniques described above may be embodied as instructions (e.g., instructions 804) directly or indirectly representative of software modules resident on a computer readable medium (e.g., disk 808) and/or resident within a computer system and/or transmitted to the computer system as part of a computer program product. As used herein, a computer-readable medium includes at least disk, tape, or other magnetic, optical, semiconductor (e.g., flash memory cards, ROM), or electronic medium and a network, wireline, wireless or other communications medium.

In addition, the integrated circuit design (810), which may be represented by at least one of an RTL design description, a gate level design description, and/or a layout design description and/or other suitable representations may be encoded on one or more computer-readable medium (e.g., disk 808). Technology libraries, timing models, and/or other suitable information, may be encoded as data (e.g., data 806) on one or more computer-readable medium (e.g., disk 808). The static timing analysis tool may be used to analyze timing paths (e.g., the timing path including devices 1002 and 1004 of FIG. 10) which are included in a design manufactured by semiconductor manufacturing processes to form a semiconductor integrated circuit (e.g., semiconductor integrated circuit 1006), as illustrated in FIG. 10.

Techniques described herein may apply to other timing constraints including recovery/removal constraints, data-to-data constraints, minimum pulse width for clock signals, or other suitable timing constraints. Other variations and modifications of the embodiments disclosed herein, may be made based on the description set forth herein, without departing from the scope and spirit of the invention as set forth in the following claims.

What is claimed is:

1. A static timing analyzer that determines, with respect to edges of a master clock signal, a signal capture event time for one of a setup timing metric and a hold timing metric associated with a signal path based on at least a signal capture event time for the other of the setup timing metric and the hold timing metric, a signal launch event time, and a type of test device associated with the signal path.

2. The static timing analyzer, as recited in claim 1, wherein the static timing analyzer determines, with respect to edges of a master clock signal, a version of the signal capture event time for the one of the setup timing metric and the hold timing metric independent from the signal capture edge of the other of the setup timing metric and the hold timing metric and adjusts at least one of the setup and hold timing metrics based on at least the independent version and the signal capture event time for the one of the setup timing metric and the hold timing metric.

3. The static timing analyzer, as recited in claim 1, wherein the signal path uses more than one transition polarity of the master clock signal for proper sequencing.

4. The static timing analyzer, as recited in claim 1, wherein a signal path comprising a first type of test device and a signal path comprising a second type of test device satisfy corresponding ones of the following relationships for a cycle time (T) of a reference signal, setup capture event time (RT_{SETUP}), setup launch event time (AT_{SETUP}), hold capture event time (RT_{HOLD}), and hold launch event time (AT_{HOLD}), the event times being with respect to particular transitions of the master clock signal:
1/T{(RT_{SETUP}−AT_{SETUP})−(RT_{HOLD}−AT_{HOLD})}=½ cycle; and
1/T{(RT_{SETUP}−AT_{SETUP})−(RT_{HOLD}−AT_{HOLD})}=1 cycle.

5. A method comprising:
determining a first timing relationship corresponding to a first timing metric of a pair of timing metrics associated with a signal path of an integrated circuit design, the first timing relationship being based on at least a second timing relationship corresponding to a second timing metric of the pair of timing metrics, a third timing relationship associated with the signal path, and a type of test device associated with the signal path,
wherein the timing relationships are with respect to particular transitions of at least one reference signal of the integrated circuit design.

6. The method, as recited in claim 5,
wherein the reference signal is a master clock signal of the integrated circuit design and the pair of timing metrics comprises a setup timing metric and a hold timing metric, and
wherein the first timing relationship and the second timing relationship are capture event times of the setup and hold timing metrics with respect to the master clock signal.

7. The method, as recited in claim 5, wherein the pair of timing metrics are based on at least the third timing relationship, a signal propagation delay associated with the signal path, and corresponding ones of the first timing relationship and the second timing relationship.

8. The method, as recited in claim 5, wherein the third timing relationship is based on at least a type of circuit element that launches a signal on the signal path.

9. The method, as recited in claim 5, further comprising:
determining a version of the first timing relationship independent from the second timing relationship; and
adjusting the independent version of the first timing relationship based on at least the first timing relationship and the second timing relationship.

10. The method, as recited in claim 5, wherein the pair of timing metrics comprises setup and hold timing metrics; and
wherein a signal path comprising a first type of test device and a signal path comprising a second type of test device satisfy corresponding ones of the following relationships for a cycle time (T) of a reference signal, setup capture event time (RT_{SETUP}), setup launch event time (AT_{SETUP}), hold capture event time (RT_{HOLD}), and hold launch event time (AT_{HOLD}), the event times being with respect to transitions of the reference signal:
1/T{(RT_{SETUP}−AT_{SETUP})−(RT_{HOLD}−AT_{HOLD})}=½ cycle; and
1/T{(RT_{SETUP}−AT_{SETUP})−(RT_{HOLD}−AT_{HOLD})}=1 cycle.

11. The method, as recited in claim 5, wherein at least one of the pair of timing metrics comprises a zero-cycle setup test.

12. The method, as recited in claim 5, wherein the signal path uses more than one transition polarity of the reference signal for proper sequencing.

13. The method, as recited in claim 5,
wherein the test device type is one of a positive edge triggered flip flop, a negative edge triggered flip flop, a level-sensitive latch transparent when an enable is high, level sensitive latch transparent when the enable is low, a nand clock gate, a nor clock gate, an and clock gate, an or clock gate, and dynamic logic.

14. The method, as recited in claim 5,
adjusting at least one of the first and second timing metrics based on at least a greatest common divisor between a first clock frequency associated with a first event of one of the pair of timing metrics and a second clock frequency associated with a second event of the one of the pair of timing metrics.

15. The method, as recited in claim 5, wherein at least one of the timing relationships are with respect to particular transitions of at least a second reference signal of the integrated circuit design.

16. The method, as recited in claim 5, embodied, at least in part, as a computer program product encoded in one or more computer readable media selected from the set of disk, tape, or other magnetic, optical, or electronic storage medium and a network, wireline, wireless, or other communication medium.

17. An integrated circuit made by the process of claim 5.

18. A computer program product encoded in at least one computer readable medium, the computer program product comprising:
instructions for determining a first timing relationship corresponding to a first timing metric of a pair of timing metrics associated with a signal path of an integrated circuit design, the first timing relationship being based on at least a second timing relationship corresponding to a second timing metric of the pair of timing metrics, a third timing relationship associated with the signal path, and a type of test device associated with the signal path,
wherein the timing relationships are with respect to particular transitions of a reference signal of the integrated circuit design.

19. The computer program product, as recited in claim 18,
wherein the reference signal is a master clock signal of the integrated circuit design and the pair of timing metrics comprises a setup timing metric and a hold timing metric, and
wherein the first timing relationship and the second timing relationship are capture event times of the setup and hold timing metrics with respect to the master clock signal.

20. The computer program product, as recited in claim 18, wherein the pair of timing metrics are based on at least the third timing relationship, a signal propagation delay associated with the signal path, and corresponding ones of the first timing relationship and the second timing relationship.

21. The computer program product, as recited in claim 18, wherein the third timing relationship is based on at least a type of circuit element that launches a signal on the signal path.

22. The computer program product, as recited in claim 18, further comprising:
instructions for determining a version of the first timing relationship independent from the second timing relationship; and
instructions for adjusting the independent version of the first timing relationship based on at least the first timing relationship and the second timing relationship.

23. The computer program product, as recited in claim 18, wherein the pair of timing metrics comprises setup and hold timing metrics; and
wherein a signal path comprising a first type of test device and a signal path comprising a second type of test device satisfy corresponding ones of the following relationships for a cycle time (T) of a reference signal, setup capture event time (RT_{SETUP}), setup launch event time (AT_{SETUP}), hold capture event time (RT_{HOLD}), and hold launch event time (AT_{HOLD}), the event times being with respect to particular transitions of the reference signal:
1/T{(RT_{SETUP}−AT_{SETUP})−(RT_{HOLD}−AT_{HOLD})}=½ cycle; and
1/T{(RT_{SETUP}−AT_{SETUP})−(RT_{HOLD}−AT_{HOLD})}=1 cycle.

24. The computer program product, as recited in claim 18, wherein at least one of the pair of timing metrics comprises a zero-cycle setup test.

25. The computer program product, as recited in claim 18, wherein the signal path uses more than one transition polarity of the reference signal for proper sequencing.

26. The computer program product, as recited in claim 18, further comprising:
instructions for adjusting at least one of the first and second timing metrics based on at least a greatest common divisor between a first clock frequency associated with a first event of one of the pair of timing metrics and a second clock frequency associated with a second event of the one of the pair of timing metrics.

27. The computer program product, as recited in claim 18, wherein the instructions form at least a portion of an integrated circuit static timing analysis tool.

28. An apparatus comprising:
means for identifying at least one signal path of an integrated circuit design for static timing analysis; and
means for determining a first timing relationship corresponding to a first timing metric of a pair of timing metrics associated with the signal path, the first timing relationship being based on at least a second timing relationship corresponding to a second timing metric of the pair of timing metrics, a third timing relationship associated with the signal path, and a type of test device associated with the signal path,
wherein the timing relationships are with respect to particular transitions of a reference signal of the integrated circuit design.

29. The apparatus, as recited in claim 28, further comprising:
means for determining a version of the first timing relationship independent from the second timing relationship; and
means for adjusting the independent version based on at least the first timing relationship.

30. The apparatus, as recited in claim 28, further comprising:
means for adjusting at least one of the first and second timing metrics based on at least a greatest common divisor between a first clock frequency associated with a first event of one of the pair of timing metrics and a second clock frequency associated with a second event of the one of the pair of timing metrics.
